(19) United States
(12) Patent Application Publication
(10) Pub. No.: US 2003/0106223 A1
(43) Pub. Date: Jun. 12, 2003

(54) Tree pruner

(76) Inventor: Pong-Chun Lee, Taichung (TW)

Correspondence Address: LAW OFFICE OF LIAUH & ASSOCIATES, 4224 WAIALAE AVENUE, SUITE 5-388, HONOLULU, HI, 96816-5307, US

(21) Appl. No.: 10/013,275

(22) Filed: Dec. 8, 2001

(51) Int. Cl. B26B 13/26

(52) U.S. Cl. 30/249; 30/245

(57) ABSTRACT

A tree pruner comprises a fixed blade, a movable blade, and a swiveling piece. The movable blade is provided with a continually slanted through slot. The swiveling piece is provided with a through slot. In conjunction with a control rod which is slidably received in the continually slanted through slot of the movable blade and the through slot of the swiveling piece, the movable blade is actuated by the swiveling piece to bring about a cutting effect in one or more steps.

### FIELD OF THE INVENTION

The present invention relates generally to a gardening implement, and more particularly to a tree pruner.

### BACKGROUND OF THE INVENTION

As shown in FIG. 1, a tree pruner of the prior art comprises a support rod 1 to which a fastening body 2 is attached. A fixed blade 3 is fastened to the fastening body 2. A pull rod 4 is pivotally fastened with the fixed blade 3. A spring 5 is disposed between the fixed blade 3 and the pull rod 4. A movable blade 6 is pivoted with the fixed blade 3. The pull rod 4 is provided with a first pulley 7, whereas the fastening body 2 is provided with a second pulley 8 which is linked with the first pulley 7 by a cord 9. As the cord 9 is pulled to actuate the pull rod 4 and the movable blade 6 to swivel, a cutting effect is brought about by the movable blade 6 in conjunction with the fixed blade 3.

Such a prior art tree pruner as described above is defective in design in that its cutting effect is insufficient to sever a coarse twig in view of the movable blade and the pull rod being pivoted at a fixed point, thereby resulting in the application point of a fixed moment of force. In addition, the prior art tree pruner can not be operated with ease in view of the fact that the pull rod 4 is provided with only one pulley.

### SUMMARY OF THE INVENTION

The primary objective of the present invention is to provide a tree pruner which is free of the deficiencies of the prior art tree pruner described above.

In keeping with the principle of the present invention, the foregoing objective of the present invintion is attained by a tree pruner comprising a fixed blade, a movable blade, and a swiveling piece. The movable blade and the swiveling piece are pivoted to the fixed blade such that the movable blade is actuated by the swiveling piece to bring about a cutting effect. The movable blade is provided with a slanted through slot. The swiveling piece is provided with an arcuate through slot. In conjunction with a control rod which is put through the slanted through slot of the movable blade and the arcuate through slot of the swiveling piece, the movable blade is actuated by the swiveling piece to bring about the cutting effect in more than one step. The swiveling piece is provided with a plurality of pulleys to make the pruning easy.

The features and the advantages of the present invention will be more readily understood upon a thoughtful deliberation of the following detailed description of the present invention with reference to the accompanying drawings.

### BRIEF DESCRIPTION OF THE DRAWINGS

FIG. 1 shows a perspective view of a tree pruner of the prior art.

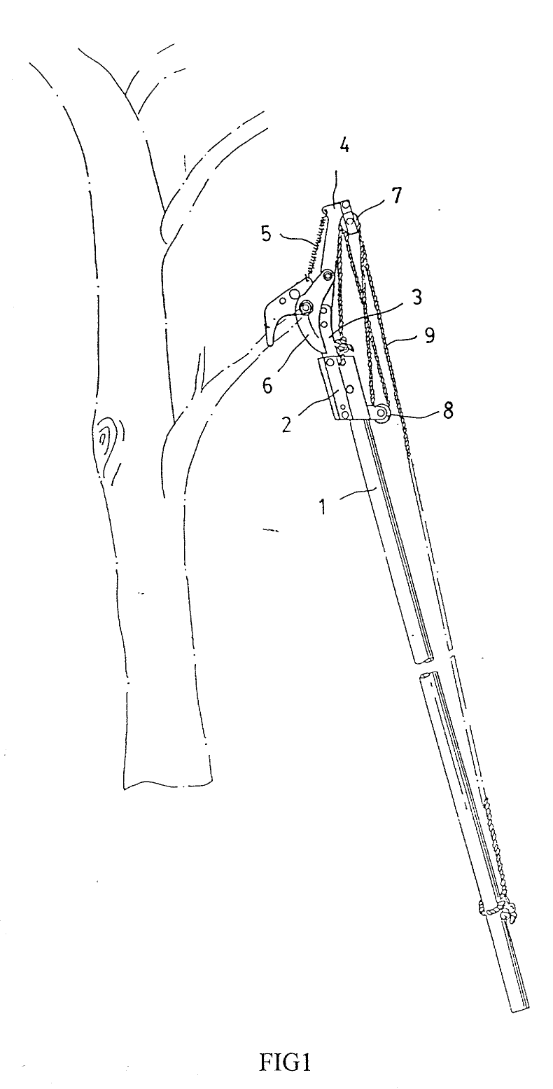

FIG. 2 shows an exploded view of the present invention.

FIG. 3 shows a perspective view of the present invention in combination.

FIG. 4 shows a schematic view of the present invention in use.

FIG. 5 shows a schematic view of the present invention in action.

FIG. 6 shows a schematic view of the adjusting of the cutting steps of the present invention.

### DETAILED DESCRIPTION OF THE INVENTION

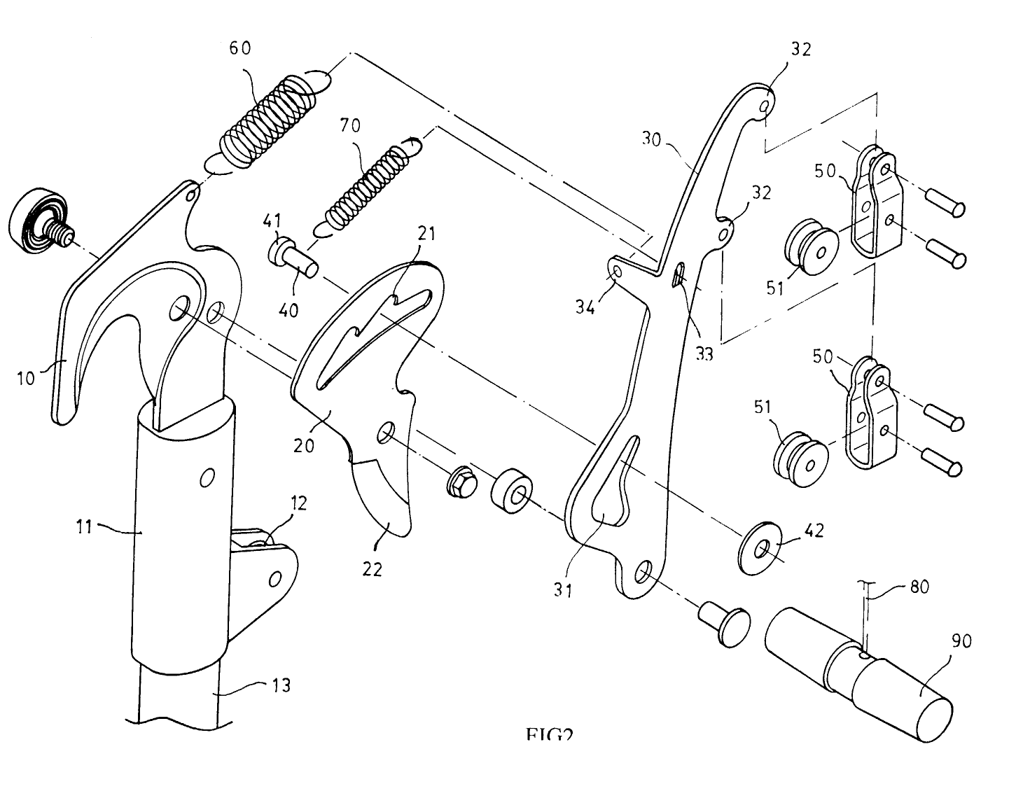

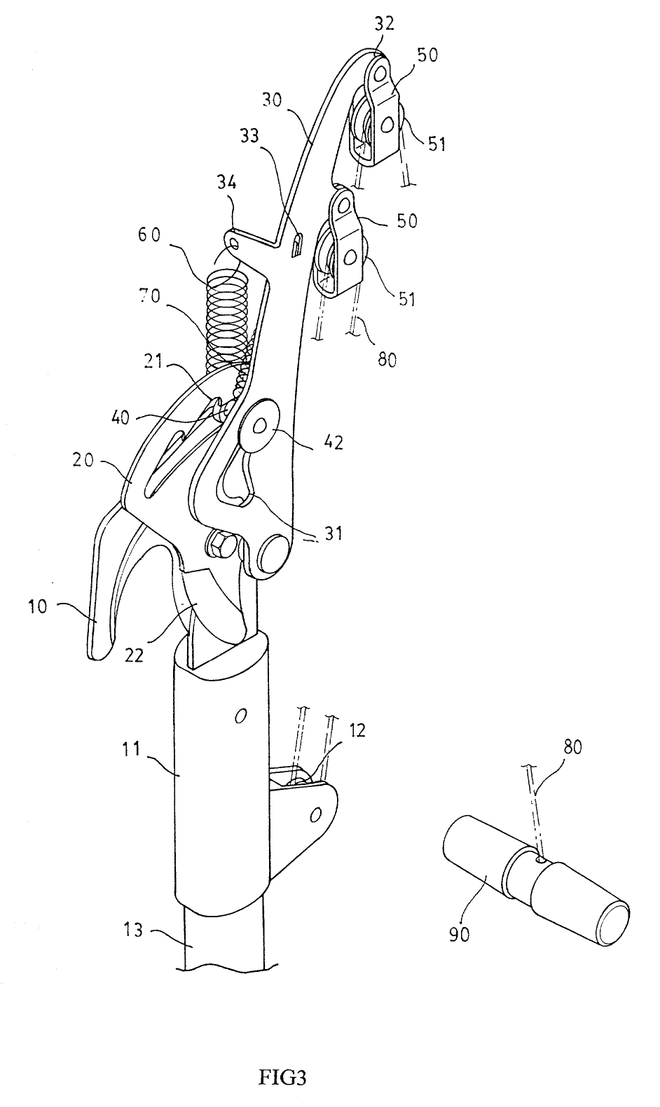

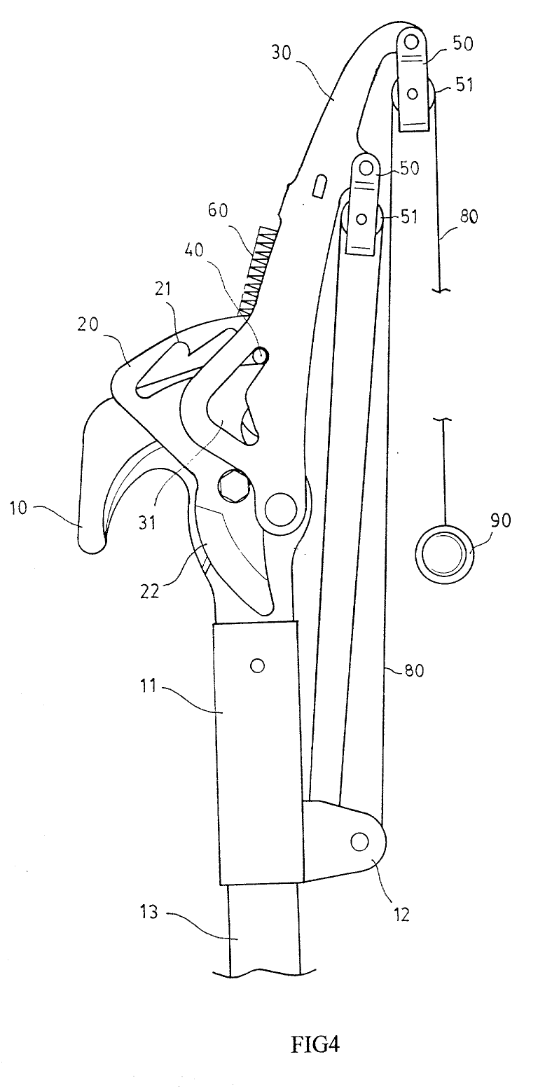

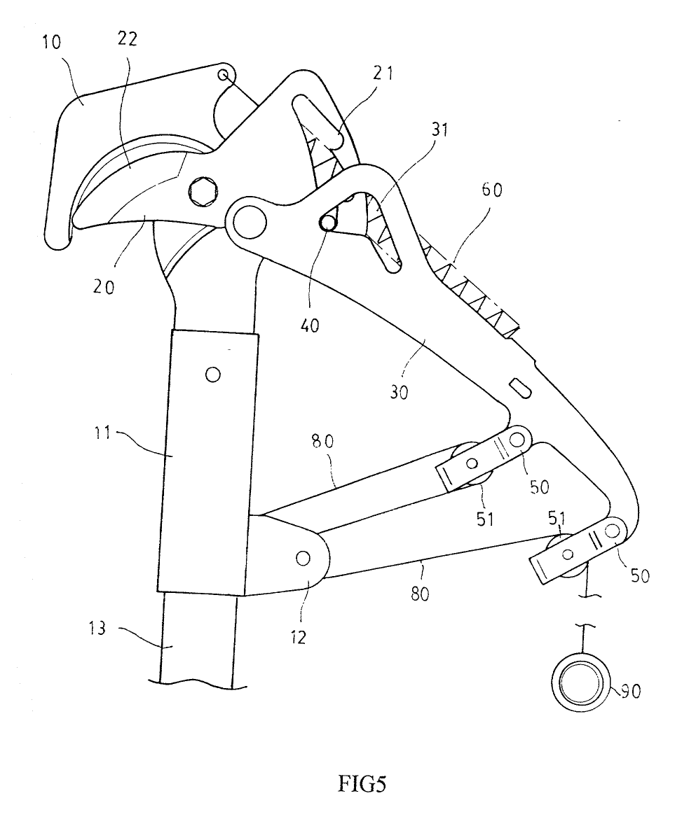

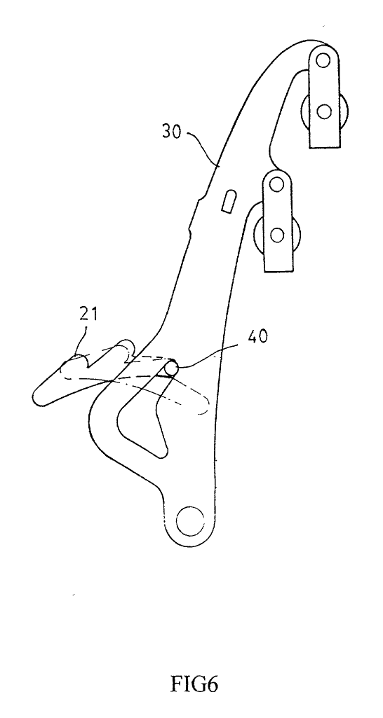

As shown in FIGS. 2-6, a tree pruner embodied in the present invention is formed of a fixed blade 10, a movable blade 20, and a swiveling piece 30.

The fixed blade 10 is fastened at the bottom end with a fastening portion 11 of a support rod 13. The fastening portion 11 is provided with a pulley 12.

The movable blade 20 is provided with a continually slanted through slot 21 and a cutting edge 22. The movable blade 20 is pivotally fastened with the fixed blade 10.

The swiveling piece 30 is provided with an arcuate through slot 31 corresponding in location to the continually slanted through slot 21 of the movable blade 20. The swiveling piece 30 is further provided with two pivoting portions 32, a hooked portion 33, and a projection 34 with a through hole. The two pivoting portions 32 are used to mount respectively a pulley frame 50 and a pulley 51.

The movable blade 20 and the swiveling piece 30 are pivoted to the fixed blade 10 in conjunction with a control rod 40, and two springs 60 and 70. The control rod 40 has a head portion 41 and a shank which is provided with a stop piece 42 fitted thereover. The control rod 40 is put through the continually slanted through slot 21 of the movable blade 20 and the arcuate through slot 31 of the swiveling piece 30 such that the head portion 41 of the control rod 40 is stopped by the side wall of the continually slanted through slot 21, and that the stop piece 42 is stopped by the side wall of the arcuate through slot 31. The first spring 60 is retained at one end thereof by the fixed blade 10 such that other end of the first spring 60 is retained by the projection 34 of the swiveling piece 30. The second spring 70 is retained at one end by the control rod 40, and at other end by the hooked portion 33 the swiveling piece 30.

The present invention further comprises a pull cord 80, which runs through the pulleys 12 and 51. The pull cord 80 is provided with a pull handle 90 fastened therewith. When the pull cord 80 is pulled by a hand holding the pull handle 90, the swiveling piece 30 is actuated to swivel downward, thereby causing the control rod 40 to be retained at a predetermined position in the continually slanted through slot 21 of the movable blade 20. As a result, the movable blade 20 is actuated in a step-by-step manner such that the cutting edge 22 of the movable blade 20 executes the cutting of a twig in conjunction with the fixed blade 10.

In operation, a tree twig to be severed is first received in a space between the fixed blade 10 and the cutting edge 22 of the movable blade 20 before the pull cord 80 is pulled with one hand holding the pull handle 90. As a result, the swiveling piece 30 is actuated by the pull cord 80 via pulleys 12 and 50 such that the swiveling piece 30 swivels downwards, and that the first spring 60 is pulled, and further that the control rod 40 is pulled by the second spring 70 to slide to locate in a slot of the continually slanted through slot 21 of the movable blade 20. The tree twig is severed by the scissors action effected by the cutting edge 22 of the movable blade 20 in conjunction with the fixed blade 10. As the pull cord 80 is let go, the swiveling piece 30 is forced by the first spring 60 to return to its original position, which is the standby position. If the tree twig is to be severed in a step-by-step manner, the pull cord 80 is pulled and then released so as to enable the second spring 70 to pull the control rod 40 to locate in a desired slot of the continually slanted through slot 21.

The present invention described above is to be regarded in all respects as being merely illustrative. Accordingly, the present invention may be embodied in other specific forms without deviating from the spirit thereof. The present invention is therefore to be limited only by the scope of the following claim.

What is claimed is:

1. A tree pruner comprising:
a support rod;
a fixed blade fastened at one end with a top end of said support rod;
a movable blade having a cutting edge opposite to said fixed blade, said movable blade being provided with a continually slanted through slot and pivoted to said fixed blade;
a swiveling piece provided with a through slot corresponding in location to said continually slanted through slot of said movable blade, said swiveling piece further provided with a plurality of pulleys pivoted therewith, said swiveling piece being fastened pivotally with said fixed blade in conjunction with a first spring whereby said first spring is fastened at one end with said fixed blade and at other end with said swiveling piece;
a control rod slidably disposed in said through slot of said swiveling member and said continually slanted through slot of said movable blade in conjunction with a second spring whereby said second spring is fastened at one end with said control rod and at other end with said swiveling member; and
a pull cord fastened at one end with said swiveling member via said pulleys of said swiveling member, said pull cord provided at other end with a pull handle fastened therewith;
said swiveling member being actuated to swivel by said pull cord at the time when said pull cord is pulled by an external force, thereby causing said first spring to be pulled to expand, and said second spring to be pulled such that said control rod is pulled to slide to locate in a slot of said continually slanted through slot of said movable blade whereby said swiveling member is forced by said first spring to return to a standby position thereof at such time when said pull cord is relieved of the external force.
